(19) United States
(12) Patent Application Publication
(10) Pub. No.: US 2023/0082204 A1
(43) Pub. Date: Mar. 16, 2023

(54) TOOL CHANGER AND MACHINE TOOL

(71) Applicant: BROTHER KOGYO KABUSHIKI KAISHA, Nagoya-shi (JP)

(72) Inventors: Shunsuke TSUJI, Nagoya-shi (JP); Kunihiko Uno, Nagoya-shi (JP)

(73) Assignee: BROTHER KOGYO KABUSHIKI KAISHA, Nagoya-shi (JP)

(21) Appl. No.: 18/058,098

(22) Filed: Nov. 22, 2022

Related U.S. Application Data
(63) Continuation of application No. PCT/JP2021/023565, filed on Jun. 22, 2021.

(30) Foreign Application Priority Data
Jun. 30, 2020 (JP) 2020-113511

(51) Int. Cl. B23Q 3/157; B23Q 3/155

(52) U.S. Cl. CPC B23Q 3/15722; B23Q 3/15539; B23Q 3/15534; B23Q 2003/155414

(57) ABSTRACT

Provided are a tool changer and a machine tool having a plurality of tool storage magazines and capable of suppressing the generation of vibration. The tool changer performs tool change between first and second tool storage magazines. The center of gravity of the second magazine is disposed below the tool change positions of the first and second magazines. Preferably, the second magazine is inclined with respect to a horizontal plane.

### REFERENCE TO RELATED APPLICATIONS

This application is a continuation application of PCT International Application No. PCT/JP2021/023565 which has an international filing date of Jun. 22, 2021 and designated the United States of America, and claiming priority from Japanese Patent Application No. 2020-113511 filed on Jun. 30, 2020. The entire content of the priority application is incorporated herein by reference.

### BACKGROUND ART

In the related art, a machine tool includes main and sub magazines for tool storage. The machine tool performs tool delivery between the main and sub magazines.

Vibration may be generated during the tool delivery between the main and sub magazines. The vibration goes down to, for example, the spindle and the workpiece holding portion of the machine tool. The machine tool has a problem in that vibration during machining causes a decline in workpiece machining accuracy.

An object of the present disclosure is to provide a tool changer and a machine tool having a plurality of tool storage magazines and capable of suppressing the generation of vibration.

### DESCRIPTION

In a tool changer of the present invention performing tool change between first and second tool storage magazines, a center of gravity of the second magazine is disposed below tool change positions of the first and second magazines.

In the tool changer of the present invention, the second magazine is stable and the generation of vibration in the second magazine can be suppressed.

The first magazine of the present invention stores a tool mounted onto a spindle of a machine tool, and the second magazine stores a tool stored by the first magazine.

The tool changer of the present invention is provided with two magazines and thus is capable of storing more tools than one magazine.

The second magazine of the tool changer of the present invention rotates around an axis inclined with respect to a horizontal plane.

In the tool changer, the center of gravity of the second magazine is lowered by the second magazine being inclined with respect to the horizontal plane.

In the tool changer of the present invention, the second magazine includes: a support disk; and an arm provided in a peripheral edge portion of the support disk and gripping a tool, one end portion of the arm protrudes outward in a radial direction of the support disk from the peripheral edge portion, and the other end portion of the arm is disposed at a position not facing a center of the support disk.

The arm of the tool changer is disposed so as to intersect a line radially extending through the center of the support disk. Accordingly, the center of gravity of the second magazine is lowered in the tool changer.

The arm of the tool changer of the present invention includes: a support plate fixed to the second magazine; and two support rods rotating on both sides of the support plate, one of the support rods has: a first part extending in a direction orthogonal to an axis of a rotation center of the second magazine; a first inclined portion extending toward one direction parallel to the axis of the rotation center from one end portion of the first part; and a first grip portion provided on the same side as the one direction in the other end portion of the first part and gripping a tool, the other support rod has: a second part extending in a direction orthogonal to the axis of the rotation center; a second inclined portion extending toward the other direction parallel to the axis of the rotation center from one end portion of the second part; and a second grip portion fixed to the same side as the other direction in the other end portion of the second part and gripping a tool, and the first grip portion and the second grip portion are at the same position in an axial direction of the rotation center.

In the axial direction of the rotation center, the directions in which the first inclined portion and the second inclined portion extend are opposite, and the positions of fixing of the first grip portion and the second grip portion are opposite, and thus the positions of fixing of the first grip portion and the second grip portion are the same. As for the tool changer, two identical support rods are prepared and disposed in opposite directions. Accordingly, the support rods on both sides are the same component and thus easy to manage.

In the tool changer of the present invention, the second magazine includes: a moving mechanism moving in a radial direction; and a pot provided in the moving mechanism and gripping a tool.

The pot grips a tool, and the moving mechanism transfers the tool gripped by the pot between the first magazine and the second magazine. The pot moves in the radial direction, and thus the moving mechanism is easy to design.

In the tool changer of the present invention, the moving mechanism is positioned on an upper side of a center of the second magazine.

The moving mechanism performs tool change on the upper side of the center of the second magazine, and thus it is easy to lower the position of the second magazine.

A machine tool of the present invention includes the tool changer described above.

In the machine tool, the center of gravity of the second magazine is disposed below the tool change positions of the first and second magazines. Accordingly, the machine tool is capable of suppressing the generation of vibration.

In the tool changer and the machine tool of the present invention, the center of gravity of the second magazine is disposed below the tool change positions of the first and second magazines, and thus the second magazine is stable and the generation of vibration in the second magazine can be suppressed.

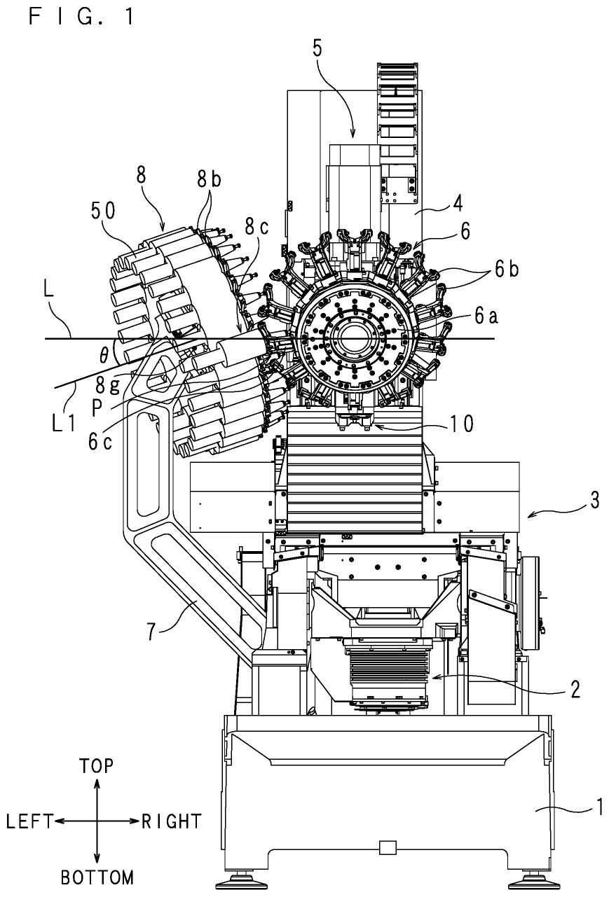

FIG. 1 is a schematic front view of a machine tool.

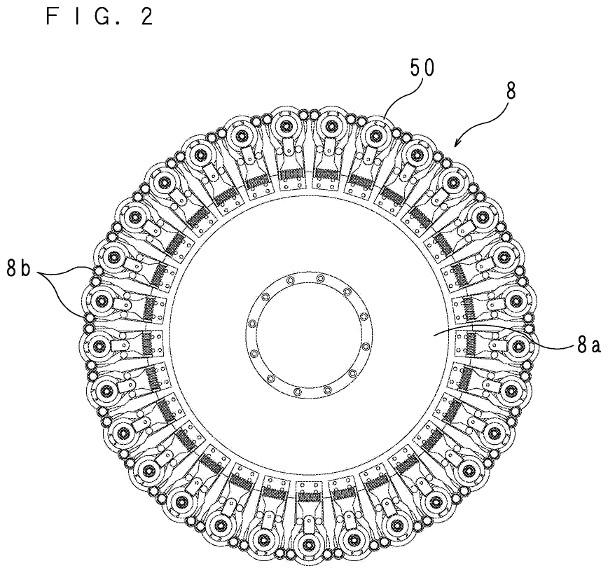

FIG. 2 is a schematic configuration diagram of a support disk and an arm of a second magazine.

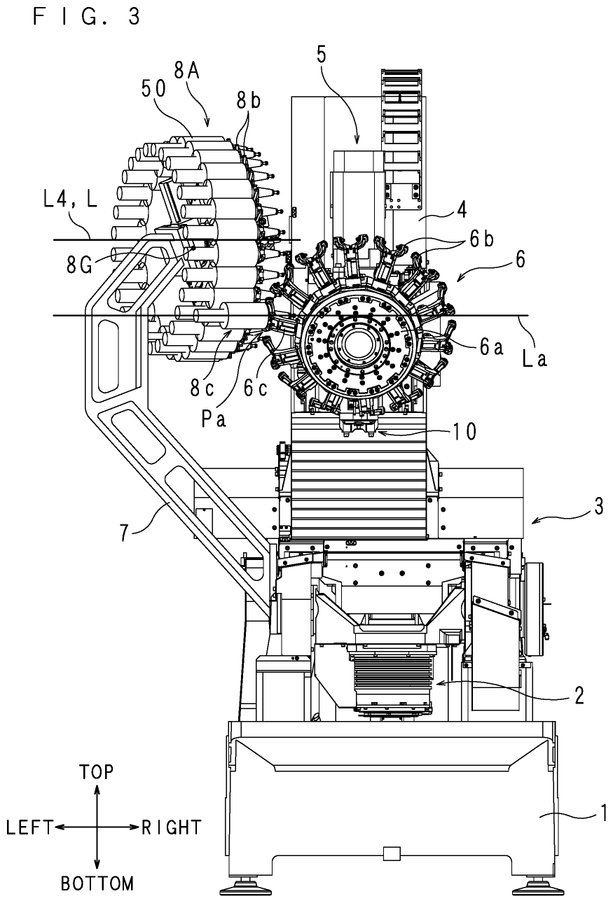

FIG. 3 is a schematic reference front view of a machine tool of the related art.

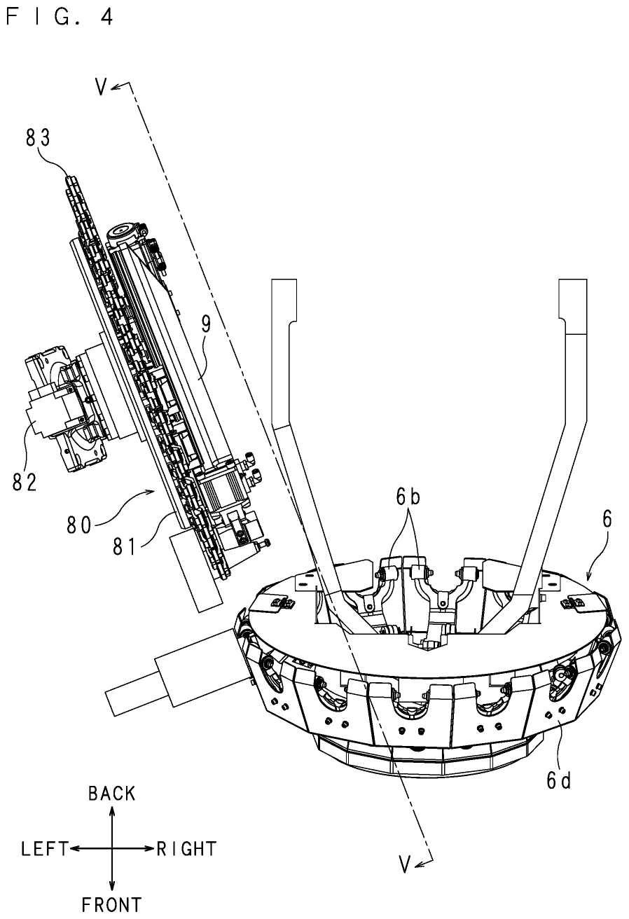

FIG. 4 is a schematic plan view of a first magazine, the second magazine, and a tool transfer device.

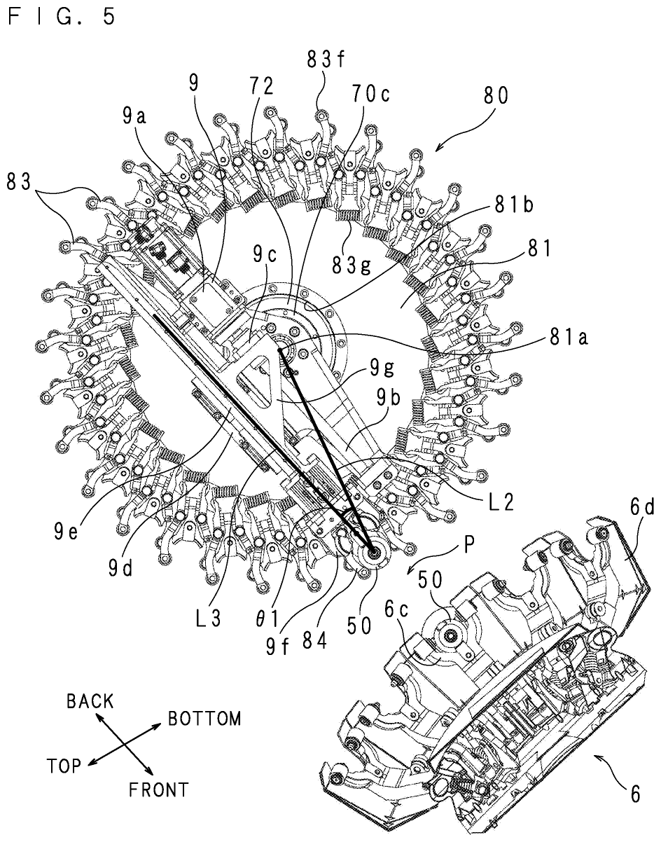

FIG. 5 is a schematic cross-sectional view taken along line V-V in FIG. 4 as a cutting line.

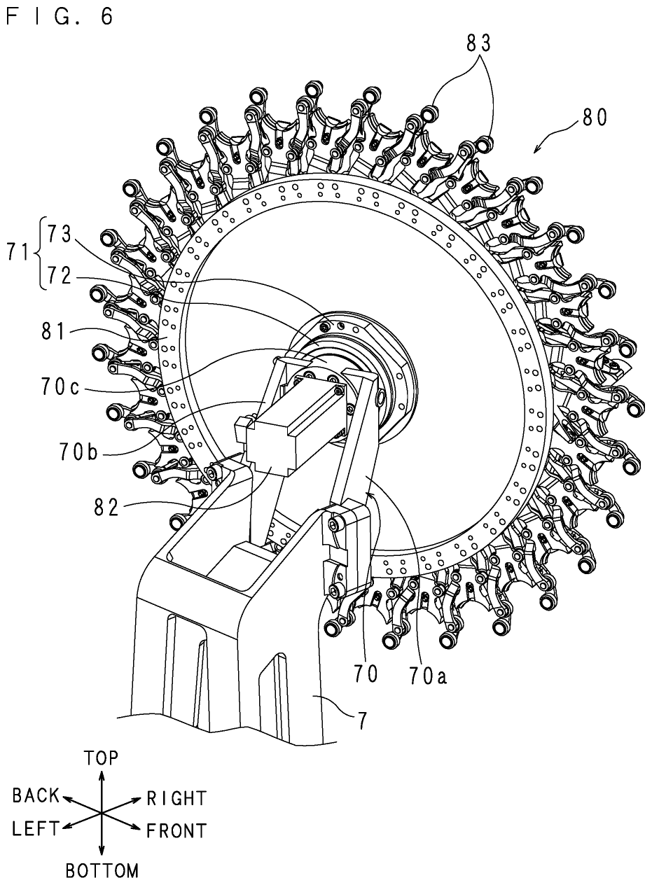

FIG. 6 is a rear perspective view of the vicinity of the second magazine.

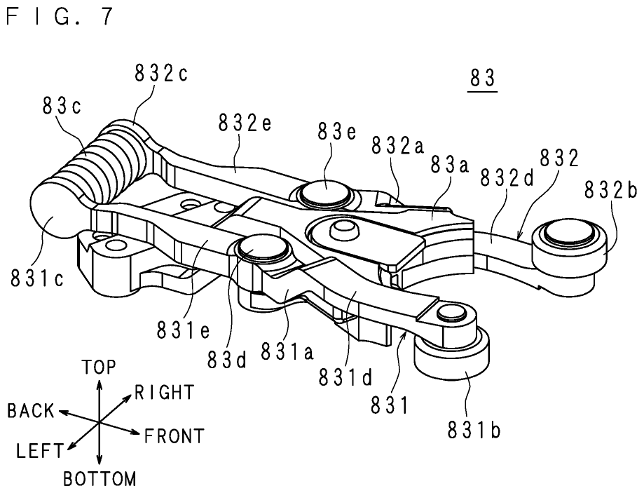

FIG. 7 is a schematic perspective view of the arm viewed from the upper left.

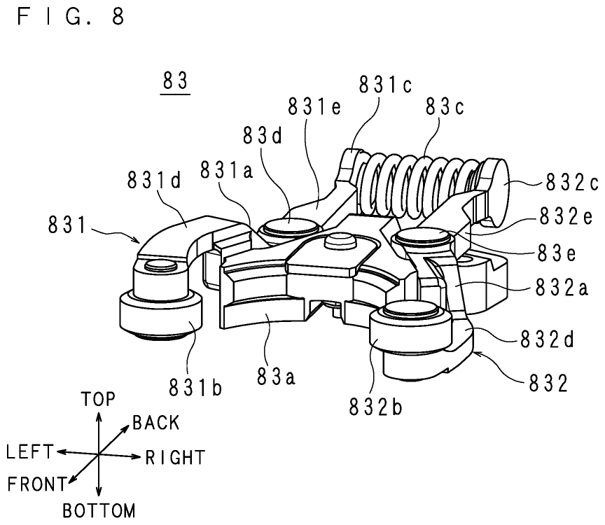

FIG. 8 is a schematic perspective view of the arm viewed from the upper right.

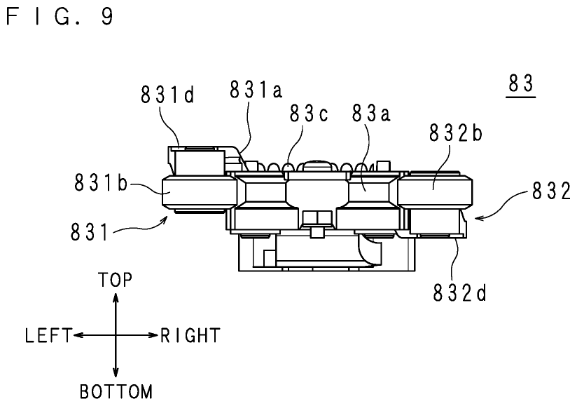

FIG. 9 is a schematic front view of the arm.

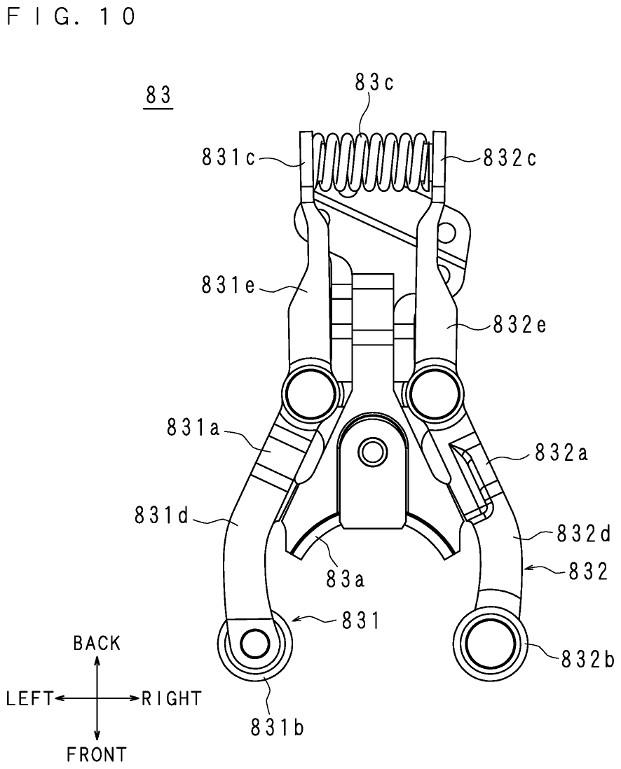

FIG. 10 is a plan view of the arm.

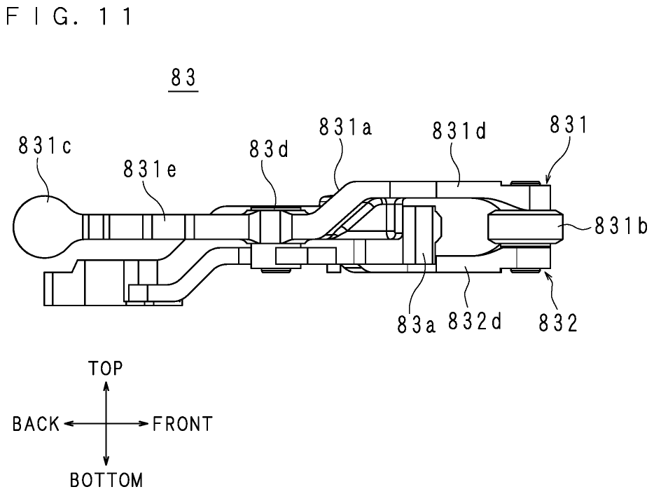

FIG. 11 is a schematic left side view of the arm.

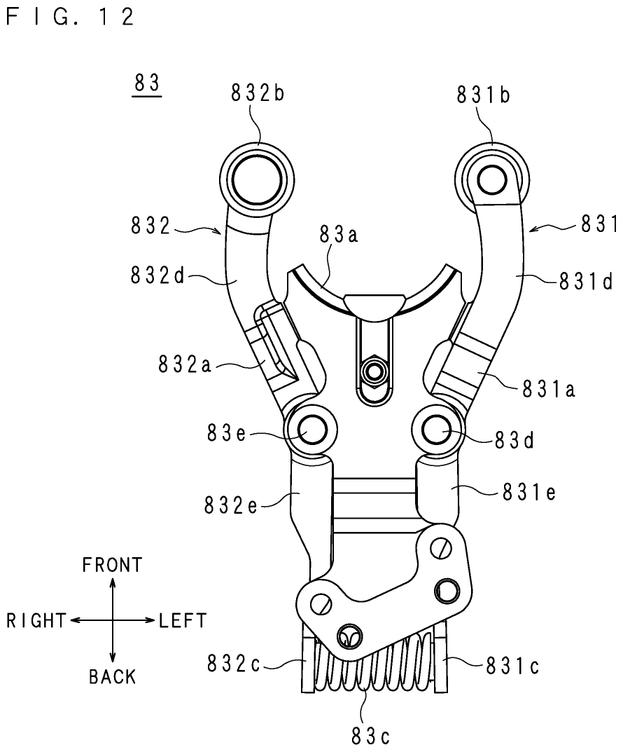

FIG. 12 is a schematic bottom view of the arm.

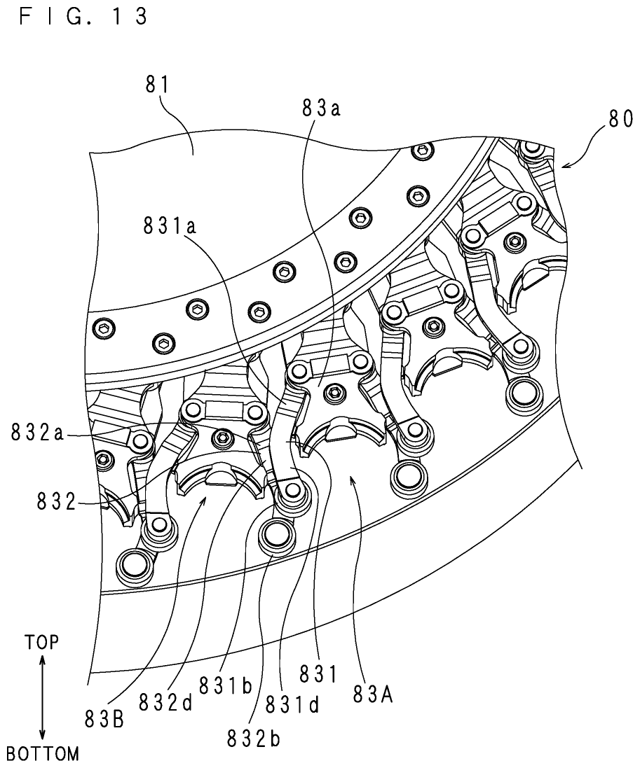

FIG. 13 is a schematic partially enlarged perspective view of the configuration of the vicinity of the arm.

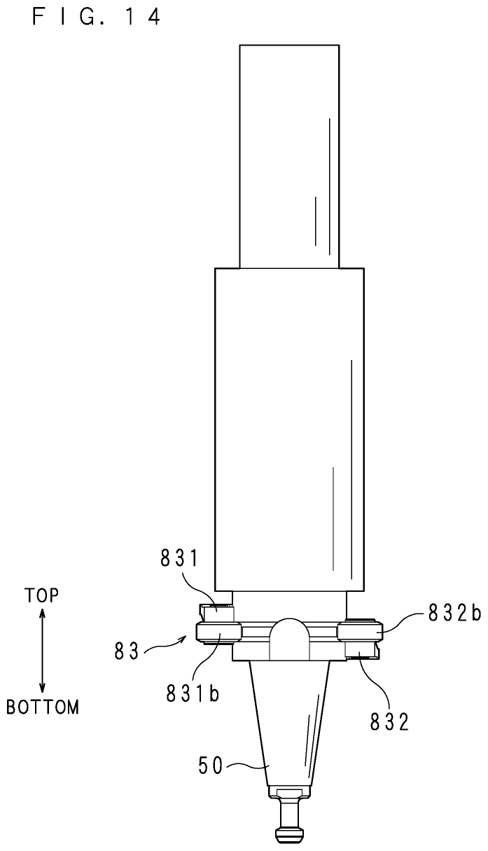

FIG. 14 is a schematic front view of a tool-gripping arm.

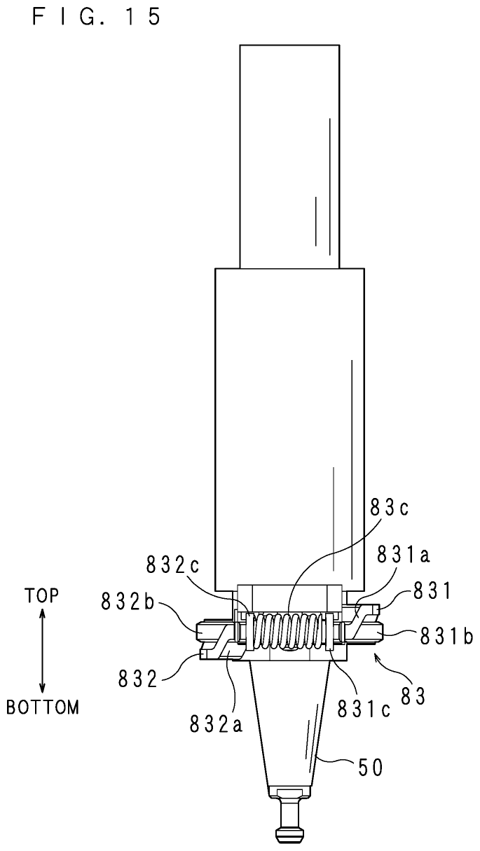

FIG. 15 is a schematic rear view of the tool-gripping arm.

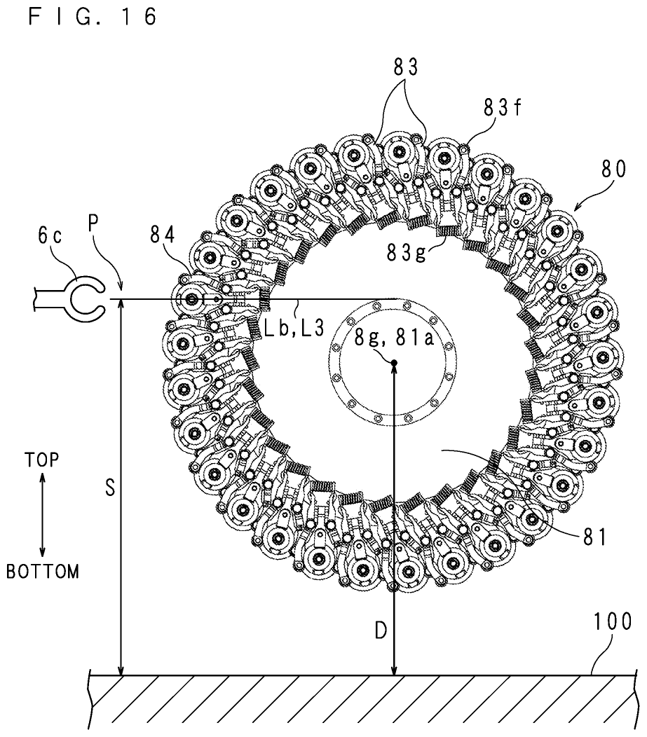

FIG. 16 is a right side view of the second magazine illustrating the relationship between the up-down distance between the installation surface of the machine tool and the center of gravity of the second magazine and the up-down distance between the installation surface and a tool change position in a case where the other end portion of the arm does not face the center.

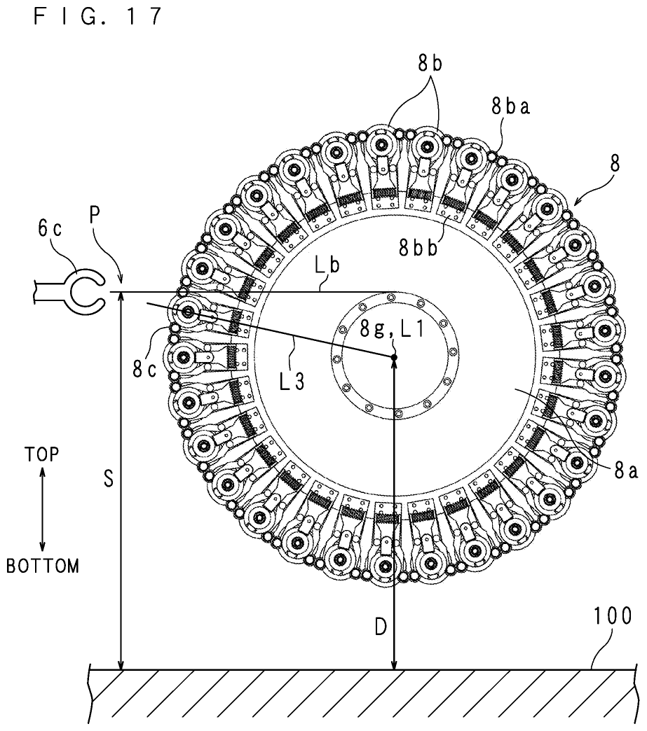

FIG. 17 is a reference right side view of the second magazine illustrating the relationship between the distance between the installation surface of the machine tool and the center of gravity of the second magazine and the distance between the installation surface and the tool change position in a case where the other end portion of the arm faces the central axis.

Hereinafter, the machine tool of the present invention will be described with reference to the drawings. In the following description, the top, bottom, front, back, left, and right illustrated in the drawings are used. In FIG. 1, L indicates a horizontal plane, and L1 indicates the central axis of a second magazine 8.

The machine tool includes, for example, a base 1, a workpiece holding portion 2, an XY moving mechanism 3, a vertical column 4, a Z moving mechanism 5, a first magazine 6, a support portion 7, the second magazine 8, a tool transfer device (not illustrated), and a spindle head 10. The first magazine 6, the support portion 7, the second magazine 8, and the tool transfer device configure a tool changer.

The base 1 has a rectangular shape in a plan view and extends in the front-rear direction. The workpiece holding portion 2 is provided on the upper front side of the base 1. On the base 1, the XY moving mechanism 3 capable of moving in the left-right direction (X direction) and the front-rear direction (Y direction) is provided on the rear side of the workpiece holding portion 2.

The vertical column 4 is provided on the upper side of the XY moving mechanism 3. The Z moving mechanism 5 capable of moving in the up-down direction (Z direction) is provided on the front surface of the vertical column 4. The Z moving mechanism 5 is provided with the spindle head 10. The spindle head 10 includes a spindle extending up and down. A tool is mounted in the lower end portion of the spindle.

The first magazine 6 is provided on the front side of the spindle head 10. The first magazine 6 is connected to the vertical column 4 via a connecting member. The first magazine 6 includes a disk 6a and arms 6b. A motor (not illustrated) is connected to the disk 6a, and the disk 6a rotates around the central axis thereof by the drive of the motor. The plurality of arms 6b are radially provided in the peripheral edge portion of the disk 6a. The arm 6b holds the tool.

The first magazine 6 is disposed such that the central axis of the disk 6a extends in the front-rear direction and the disk 6a is in a forward leaning posture. The lower end position of the first magazine 6 is a tool change position. In a case where the tool is mounted on the spindle, the arm 6b gripping the tool is disposed at the tool change position, and the Z moving mechanism 5 is moved downward. Based on the downward movement of the Z moving mechanism 5, the tool gripped by the arm 6b is mounted on the spindle. In a case where the tool is removed from the spindle, the arm 6b that is empty is disposed at the tool change position, and the Z moving mechanism 5 is moved upward. Based on the upward movement of the Z moving mechanism 5, the arm 6b grips the tool of the spindle, and the tool is released from the spindle.

The tool mounted on the spindle processes the workpiece held in the workpiece holding portion 2. The XY moving mechanism 3 adjusts the front-rear and left-right positions of the tool (spindle) with respect to the workpiece, and the Z moving mechanism 5 adjusts the up-down position of the tool.

The support portion 7 is provided on the rear side of the left portion of the base 1. The support portion 7 extends upward, and the second magazine 8 is provided in the tip portion thereof. The second magazine 8 is disposed on the left side and the rear side of the first magazine 6. The second magazine 8 includes the tool transfer device. The tool transfer device performs tool delivery between the arm 6b of the first magazine 6 and an arm 8b of the second magazine 8.

FIG. 2 is a diagram viewed from the axial direction of a support disk 8a. The second magazine 8 includes the support disk 8a and the arm 8b. A motor (not illustrated) is connected to the support disk 8a, and the support disk 8a rotates around the central axis L1 (see FIG. 1) by the drive of the motor. The central axis L1 of the support disk 8a is the axis of the center of rotation and is a virtual axis.

As illustrated in FIG. 1, one surface of the support disk 8a (see FIG. 2) faces diagonally rearward to the right, the other surface faces diagonally forward to the left, and the central axis L1 intersects the horizontal plane L. In a plan view, the central axis L1 extends diagonally forward to the left and diagonally rearward to the right. The front side of the central axis L1 is positioned below the horizontal plane L, and the rear side of the central axis L1 is positioned above the horizontal plane L. The central axis L1 and the horizontal plane L form a predetermined angle θ.

In a case where the horizontal plane L passing through the central axis of the first magazine 6 is set, the arm 6b of the first magazine 6 and the arm 8b of the second magazine 8 are closest to each other at a position below the horizontal plane L. The position where the arm 6b of the first magazine 6 and the arm 8b of the second magazine 8 are closest to each other is a magazine tool change position P where the tool of the first magazine 6 and the tool of the second magazine 8 are changed. Hereinafter, the arm 6b of the first magazine 6 arranged at the magazine tool change position P will be referred to as a change position arm 6c, and the arm 8b of the second magazine 8 arranged at the magazine tool change position P will be referred to as a change position arm 8c. The machine tool performs tool change between the change position arm 6c and the change position arm 8c.

A center of gravity 8g of the second magazine 8 is disposed below the horizontal plane L, that is, below the magazine tool change position P.

Since the center of gravity 8g of the second magazine 8 is disposed below the magazine tool change position P of the first magazine 6 and the second magazine 8, the second magazine 8 is stable and the generation of vibration in the second magazine 8 can be suppressed.

FIG. 3 is a schematic reference front view of a machine tool of the related art. La in FIG. 3 indicates the up-down position of a magazine tool change position Pa. A central axis L4 of a second magazine 8A is parallel to the horizontal plane L. In a case where the central axis L4 and the horizontal plane L are parallel, a center of gravity 8G of the second magazine 8A is positioned above the magazine tool change position Pa. Since the position of the center of gravity is higher in the machine tool of FIG. 3 than in the machine tool of FIG. 1, the second magazine 8A tends to be unstable and it is difficult to suppress the vibration in the second magazine 8A.

Since the center of gravity 8g of the second magazine 8 of FIG. 1 is disposed below the magazine tool change position P, the second magazine 8 is stable and the machine tool is capable of suppressing the generation of vibration in the second magazine 8. The second magazine 8 may be provided on the right side of the first magazine 6.

Hereinafter, other examples of the present invention will be described with reference to the drawings. The same reference numerals are given to configurations similar to those in the above example, and detailed description thereof will be omitted.

The cutting line of FIG. 5 is orthogonal to the central axis of a support disk 81. The first magazine 6 includes a cover 6d. The cover 6d covers the outside of each arm 6b. The cover 6d is rotatable, rotates together with the arm 6b during tool change with the spindle, and does not hinder the tool change.

As illustrated in FIG. 6, an attachment member 70 is fixed to the upper end portion of the support portion 7. The attachment member 70 includes a front plate portion 70a, a rear plate portion 70b, and a support cylinder 70c. The front plate portion 70a and the rear plate portion 70b extend in the upper right direction from the upper end portion of the support portion 7 and are arranged in the front-rear direction. The axial direction of the support cylinder 70c is the left-right direction, and the support cylinder 70c is connected to the upper end portions of the front plate portion 70a and the rear plate portion 70b.

A reduction gear device 71 is connected to the right portion of the support cylinder 70c. The reduction gear device 71 has an annular inner peripheral portion 72 and an outer peripheral portion 73. The inner peripheral portion 72 is fixed to the peripheral edge portion of the support cylinder 70c. The outer peripheral portion 73 is attached around the inner peripheral portion 72 so as to be rotatable around the axis. In other words, the inner peripheral portion 72 rotatably supports the outer peripheral portion 73.

A second magazine 80 includes the support disk 81, a motor 82, and arms 83. The motor 82 is connected to the left portion of the support cylinder 70c. The support disk 81 is disposed on the right side of the reduction gear device 71 with both surfaces facing left and right. The right surface of the support disk 81 faces slightly rearward, and the left surface faces slightly forward. A through hole 81b (see FIG. 5) penetrating the support disk 81 in the left-right direction is provided in the middle portion of the support disk 81. The support cylinder 70c and the inner peripheral portion 72 extend in the axial direction and are inserted into the through hole 81b. The outer peripheral portion 73 is connected to the inner peripheral part of the through hole 81b. The outer peripheral portion 73 is rotated by the drive of the motor 82, and the support disk 81 rotates around the central axis thereof. The plurality of arms 83 are radially provided in the peripheral edge portion of the support disk 81. The arm 83 holds a tool.

The grip arm 6b of the first magazine 6 and the grip arm 83 of the second magazine 80 are closest to each other at a position below a central axis 81a. The position where the grip arm 6b of the first magazine 6 and the grip arm 83 of the second magazine 80 are closest to each other is the magazine tool change position P where the tool of the first magazine 6 and the tool of the second magazine 80 are changed. Hereinafter, the arm 6b of the first magazine 6 arranged at the magazine tool change position P will be referred to as the change position arm 6c, and the grip arm 83 of the second magazine 80 arranged at the magazine tool change position P will be referred to as a change position arm 84. Tool change is performed between the change position arm 6c and the change position arm 84. One end portion 83f of the grip arm 83 protrudes radially outward from the peripheral edge portion of the support disk 81.

In FIG. 5, L2 indicates a line passing through the central axis 81a of the support disk 81 and the center of a tool 50 gripped by the change position arm 84, and L3 indicates a line along the longitudinal direction of the change position arm 84. The line L3 passes through the middle of the change position arm 84. The line L2 and the line L3 intersect to form a predetermined angle θ1 (>0). Since each arm 83 positioned at the magazine tool change position P is disposed so as to form the predetermined angle θ1, the other end portion 83g of the arm 83 does not face the central axis 81a of the support disk 81.

A tool transfer device 9 is provided on the right side of the support disk 81. The tool transfer device 9 includes a motor 9a, a ball screw 9b, a nut 9c, a track 9d, a slider 9e, a pot 9f, and a connecting portion 9g. The motor 9a, the ball screw 9b, the nut 9c, the track 9d, the slider 9e, and the connecting portion 9g configure a moving mechanism. The moving mechanism is positioned on the upper side of the central axis 81a of the support disk 81. The support cylinder 70c and the inner peripheral portion 72 inserted in the through hole 81b support the ball screw 9b and the track 9d. The ball screw 9b is connected to the rotating shaft of the motor 9a. The nut 9c is connected to the ball screw 9b.

As illustrated in FIG. 5, the track 9d is disposed next to the ball screw 9b. The track 9d is fixed at a position off the central axis 81a of the support disk 81. The track 9d extends along the longitudinal direction of the change position arm 84. One end portion of the track 9d faces the change position arm 84. The slider 9e is slidably provided on the track 9d. The pot 9f is attached to the slider 9e. The connecting portion 9g connects the slider 9e and the nut 9c. By the drive of the motor 9a, the ball screw 9b rotates, the nut 9c moves along the ball screw 9b, and the slider 9e, the connecting portion 9g, and the pot 9f move along the track 9d. The pot 9f grabs the tool 50 gripped by the change position arm 84 and passes the tool 50 to the change position arm 6c that is empty or grabs the tool 50 gripped by the change position arm 6c and passes the tool 50 to the change position arm 84 that is empty. As illustrated in FIG. 5, the center of gravity 8g of the second magazine 80 is near the central axis 81a and is positioned below the center of the first magazine 6.

As illustrated in FIGS. 5 and 6, the plurality of arms 83 are arranged along the peripheral edge portion of the support disk 81. The arm 83 extends in the radial direction of the support disk 81. Hereinafter, the configuration of the arm 83 will be described.

As illustrated in FIGS. 7 and 8, the arm 83 includes a first support rod 831 and a second support rod 832. A support plate 83a, the first support rod 831, and the second support rod 832 extend in the front-rear direction. The front end portion of the support plate 83a has a plan-view circular arc shape protruding to the rear side. The first support rod 831 and the second support rod 832, which are separated from each other in the left-right direction, are disposed on the left side and the right side of the support plate 83a, respectively.

The front-rear-direction midway portion of the first support rod 831 is connected to the front-rear-direction midway portion of the support plate 83a via a pivot 83d, the axial direction of which is the up-down direction. The front-rear-direction midway portion of the second support rod 832 is connected to the front-rear-direction midway portion of the support plate 83a via a pivot 83e, the axial direction of which is the up-down direction.

The side of the first support rod 831 in front of the pivot 83d is referred to as a front side part 831d, and the side of the first support rod 831 behind the pivot 83d is referred to as a rear side part 831e. The side of the second support rod 832 in front of the pivot 83e is referred to as a front side part 832d, and the side of the second support rod 832 behind the pivot 83e is referred to as a rear side part 832e. The front side part 831d of the first support rod 831 is curved so as to protrude to the left side. The front side part 832d of the second support rod 832 is curved so as to protrude to the right side. The front end portion of the support plate 83a, which has a circular arc shape, is disposed between the front side parts 831d and 832d of the first support rod 831 and the second support rod 832.

A spring seat 831c is provided in the rear end portion of the first support rod 831. A spring seat 832c is provided in the rear end portion of the second support rod 832. The two spring seats 831c and 832c form a circular plate shape and face each other in the left-right direction. A push spring 83c is provided between the two spring seats 831c and 832c. The push spring 83c urges the two spring seats 831c and 832c such that the two spring seats 831c and 832c are separated from each other in the left-right direction.

The front side part 831d of the first support rod 831 is positioned to the left of the rear side part 831e. An inclined portion 831a connects the front side part 831d and the rear side part 831e. The inclined portion 831a is inclined so as to extend downward from the rear end portion of the front side part 831d toward the rear side. A roller 831b is provided on the lower surface of the front end portion of the front side part 831d. The front side part 831d configures a first part, and the inclined portion 831a configures a first inclined portion. The roller 831b configures a first grip portion. The up-down direction is parallel to the axial direction of the rotation center of the second magazine 80.

The front side part 832d of the second support rod 832 is positioned to the right of the rear side part 832e. An inclined portion 832a connects the front side part 832d and the rear side part 832e. The inclined portion 832a is inclined so as to extend upward from the rear end portion of the front side part 832d toward the rear side. A roller 832b is provided on the upper surface of the front end portion of the front side part 832d. The front side part 832d configures a second part, the inclined portion 832a configures a second inclined portion, and the roller 832b configures a second grip portion.

The first support rod 831 and the second support rod 832 are the same component and are simply upside down. The positions of the pivot 83d and the pivot 83e are the same in the direction parallel to the axial direction of the rotation center of the tool magazine 80. The inclination directions of the inclined portion 831a and the inclined portion 832a are opposite to each other, and the inclined portion 831a and the inclined portion 832a have the same inclination angle magnitude. The inclined portion 831a and the inclined portion 832a have the same length. Accordingly, the positions of the roller 831b and the roller 832b are the same in the direction parallel to the axial direction of the rotation center of the tool magazine.

As illustrated in FIG. 13, the plurality of arms 83 are arranged along the peripheral edge portion of the support disk 81. The plurality of arms 83 include a first arm 83A and a second arm 83B positioned next to the first arm 83A. The front side part 831d of the first arm 83A is positioned on the upper side of the front side part 832d of the second arm 83B. In other words, in the adjacent first arm 83A and second arm 83B, the positions of the front side part 831d of the first arm 83A and the front side part 832d of the second arm 83B are misaligned in the up-down direction, that is, in the axial direction of the support disk 81.

As described above, the line L2 and the line L3 intersect to form the predetermined angle θ1. Accordingly, the first arm 83A and the second arm 83B, that is, the two adjacent arms 83 are at the same position at least in part in the circumferential direction of the support disk 81. However, the front side parts 831d and 832d overlap in the direction parallel to the central axis 81a, that is, the positions of the front side parts 831d and 832d are misaligned in the axial direction of the support disk 81, and thus the two arms 83 adjacent to each other in the circumferential direction do not interfere with each other.

As illustrated in FIGS. 14 and 15, the tool 50 is mounted between the front side parts 831d and 832d of the first support rod 831 and the second support rod 832. The rollers 831b and 832b hold the tool 50 by the urging force of the push spring 83c.

Hereinafter, the machine tool will be described with reference to FIGS. 16 and 17. D indicates the up-down distance between an installation surface 100 of the machine tool and the center of gravity 8g of the second magazine 80, and S indicates the up-down distance between the installation surface 100 and the magazine tool change position P. A line Lb indicates the up-down position of the magazine tool change position P. The center of gravity 8g of the second magazine 80 is positioned near the central axis 81a of the second magazine 80 and is positioned below the magazine tool change position P. In other words, the change position arms 6c and 84 are positioned above the center of gravity 8g, and the distance D is shorter than the distance S. The line L3 passing through the middle of the change position arm 84 is horizontal, and the change position arm 84 is face to face with the change position arm 6c.

FIG. 17 is a diagram corresponding to FIG. 16 in a case where the other end portion of the arm 8b faces the central axis L1. The configuration of the second magazine 8 is similar to the configuration of the second magazine 8 of FIGS. 1 and 2. One end portion 8ba of the arm 8b protrudes radially outward from the peripheral edge portion of the support disk 8a. The other end portion 8bb of the arm 8b faces the central axis L1 of the support disk 8a. The position of the change position arm 6c and the magazine tool change position P are the same in FIGS. 16 and 17, and thus the distance S is also the same.

The center of gravity 8g of the second magazine 8 is positioned near the central axis L1 of the second magazine 8 and is below the magazine tool change position P. In this case, the line L3 passing through the middle of the change position arm 8c is diagonal, and the change position arm 8c is not face to face with the change position arm 6c. Accordingly, in the case of tool change between the change position arms 8c and 6c, problems such as incomplete tool gripping and tool dropping may arise. In order for the change position arm 8c to be face to face with the change position arm 6c, it is necessary to move the second magazine 8 upward such that the arm below and next to the change position arm 8c of FIG. 17 serves as a change position arm.

By setting the orientation of the arm 83 such that the other end portion 83g does not face the central axis 81a (FIG. 16), the change position arm 84 is face to face with the change position arm 6c and the distance between the installation surface 100 and the center of gravity 8g can be shortened as compared with a case where the other end portion 8bb faces the central axis L1. In other words, tool change can be smoothly executed and the center of gravity 8g of the second magazine 80 can be lowered.

Another tool changer and another machine tool are disposed such that the line L2 extending in the radial direction in which the arm 83 passes through the center of the support disk 81 and the line L3 extending in the longitudinal direction of the arm 83 intersect. With such a disposition, tool change can be smoothly executed and the center of gravity of the second magazine 80 is lowered.

The pot 9f grips the tool 50, and the moving mechanism transfers the tool 50 gripped by the pot 9f between the first magazine 6 and the second magazine 80. The moving mechanism performs tool change on the upper side of the center of the second magazine 80, and thus it is easy to lower the position of the second magazine 80.

The central axis (rotation center axis) L1 of the first magazine 6 may be inclined with respect to the horizontal plane or may be parallel to the horizontal plane. Although the tool transfer device is not illustrated in Embodiment 1, the tool transfer device of Embodiment 1 is similar in configuration to the tool transfer device 9 of Embodiment 2.

The embodiments disclosed this time are exemplary in all respects and are not restrictive. The technical features described in the examples can be combined with each other and the scope of the present invention includes all modifications within the claims and scopes equivalent to the claims.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

What is claimed is:

1. A tool changer performing tool change between first and second tool storage magazines, wherein
a center of gravity of the second magazine is disposed below tool change positions of the first and second magazines.

2. The tool changer according to claim 1, wherein
the first magazine configured to store a tool mounted onto a spindle of a machine tool, and
the second magazine configured to store a tool stored by the first magazine.

3. The tool changer according to claim 2, wherein
the second magazine is rotatable around an axis inclined with respect to a horizontal plane.

4. The tool changer according to claim 1, wherein
the second magazine includes
a support disk; and
an arm provided in a peripheral edge portion of the support disk and configured to grip a tool, one end portion of the arm protruding outward in a radial direction of the support disk from the peripheral edge portion, and the other end portion of the arm being disposed at a position not facing a center of the support disk.

5. The tool changer according to claim 4, wherein
the arm includes:
a support plate fixed to the second magazine; and
two support rods configured to rotate on both sides of the support plate,
one of the support rods has:
a first part extending in a direction orthogonal to an axis of a rotation center of the second magazine,
a first inclined portion extending toward one direction parallel to the axis of the rotation center from one end portion of the first part; and
a first grip portion provided on the same side as the one direction in the other end portion of the first part and gripping a tool.

6. The tool changer according to claim 1, wherein
the second magazine includes:
a moving mechanism configured to move in a radial direction; and
a pot provided in the moving mechanism and configured to grip a tool.

7. The tool changer according to claim 6, wherein
the moving mechanism is positioned on an upper side of a center of the second magazine.

8. A machine tool comprising the tool changer according to claim 1.
